(19) United States
(12) Patent Application Publication
(10) Pub. No.: US 2015/0213524 A1
(43) Pub. Date: Jul. 30, 2015

(54) Automated Importation System and Method

(71) Applicants: Mark Unak, Milwaukee, WI (US); Sanjay Argawal, Naperville, IL (US); Vivek Shivaprabhu, Chicago, IL (US)

(72) Inventors: Mark Unak, Milwaukee, WI (US); Sanjay Argawal, Naperville, IL (US); Vivek Shivaprabhu, Chicago, IL (US)

(21) Appl. No.: 14/607,731

(22) Filed: Jan. 28, 2015

Related U.S. Application Data
(60) Provisional application No. 61/932,451, filed on Jan. 28, 2014.

(51) Int. Cl. G06Q 30/06; G06F 17/30

(52) U.S. Cl. CPC G06Q 30/0601; G06F 17/30896

(57) ABSTRACT

A method, computer program product, and computing system for identifying a first product offered by a product distributor within an electronic distributor catalog for inclusion within a master catalog. The first product is processed to extract one or more product attributes for the first product. The one or more product attributes for the first product are compared with one or more catalog attributes utilized within the master catalog to map at least one of the one or more product attributes for the first product onto at least one of the one or more catalog attributes utilized within the master catalog.

### RELATED APPLICATION

This application claims the benefit of U.S. Provisional Patent Application No. 61/932,451, filed on 28 Jan. 2014 and entitled “Data Importation System and Method”; the entire contents of which are herein incorporated by reference.

### TECHNICAL FIELD

This disclosure relates to automated importation systems and, more particularly, to automated systems for importing products into catalogs.

### BACKGROUND

Online sales are growing exponentially, with online resellers (e.g., Amazon.com™) offering for sale products that are manufactured by third parties. Additionally, traditional “bricks-n-mortar” companies like Home Depot™, Lowes™, and Sears™ are also aggregating third-party products for sale via their online presence (e.g., HomeDepot.com™, Lowes.com™ and Sears.com™).

Unfortunately, the process of obtaining product information concerning the third-party products to be offered for sale online and incorporating such third-party, product information into the online presence of these resellers can be time consuming and difficult.

### SUMMARY OF DISCLOSURE

In one implementation, a computer-implemented method, executed on a computing device, includes identifying a first product offered by a product distributor within an electronic distributor catalog for inclusion within a master catalog. The first product is processed to extract one or more product attributes for the first product. The one or more product attributes for the first product are compared with one or more catalog attributes utilized within the master catalog to map at least one of the one or more product attributes for the first product onto at least one of the one or more catalog attributes utilized within the master catalog.

One or more of the following features may be included. Comparing the one or more product attributes for the first product with one or more catalog attributes utilized within the master catalog may include reviewing historical/current product attribute mappings within the master catalog to map at least one of the one or more product attributes for the first product onto at least one of the one or more catalog attributes utilized within the master catalog. Comparing the one or more product attributes for the first product with one or more catalog attributes utilized within the master catalog nay include reviewing attributes names included within the one or more product attributes for the first product with attribute names included within the one or more catalog attributes utilized within the master catalog to map at least one of the one or more product attributes for the first product onto at least one of the one or more catalog attributes utilized within the master catalog. Comparing the one or more product attributes for the first product with one or more catalog attributes utilized within the master catalog may include reviewing attributes values included within the one or more product attributes for the first product with attribute values included within the one or more catalog attributes utilized within the master catalog to map at least one of the one or more product attributes for the first product onto at least one of the one or more catalog attributes utilized within the master catalog.

Additional products offered by the product distributor within the electronic distributor catalog may be identified for inclusion within the master catalog. The additional products may be processed to extract one or more product attributes for each of the additional products. The one or more product attributes for each of the additional products may be compared with the one or more catalog attributes utilized within the master catalog to map at least one of the one or more product attributes for the additional products onto at least one of the one or more catalog attributes utilized within the master catalog. The electronic distributor catalog may be provided in a format chosen from the group consisting of: a spreadsheet format and XML format. The master catalog may be an online catalog.

In another implementation, a computer program product resides on a computer readable medium that has a plurality of instructions stored on it. When executed by a processor, the instructions cause the processor to perform operations including identifying a first product offered by a product distributor within an electronic distributor catalog for inclusion within a master catalog. The first product is processed to extract one or more product attributes for the first product. The one or more product attributes for the first product are compared with one or more catalog attributes utilized within the master catalog to map at least one of the one or more product attributes for the first product onto at least one of the one or more catalog attributes utilized within the master catalog.

One or more of the following features may be included. Comparing the one or more product attributes for the first product with one or more catalog attributes utilized within the master catalog may include reviewing historical/current product attribute mappings within the master catalog to map at least one of the one or more product attributes for the first product onto at least one of the one or more catalog attributes utilized within the master catalog. Comparing the one or more product attributes for the first product with one or more catalog attributes utilized within the master catalog nay include reviewing attributes names included within the one or more product attributes for the first product with attribute names included within the one or more catalog attributes utilized within the master catalog to map at least one of the one or more product attributes for the first product onto at least one of the one or more catalog attributes utilized within the master catalog. Comparing the one or more product attributes for the first product with one or more catalog attributes utilized within the master catalog may include reviewing attributes values included within the one or more product attributes for the first product with attribute values included within the one or more catalog attributes utilized within the master catalog to map at least one of the one or more product attributes for the first product onto at least one of the one or more catalog attributes utilized within the master catalog.

Additional products offered by the product distributor within the electronic distributor catalog may be identified for inclusion within the master catalog. The additional products may be processed to extract one or more product attributes for each of the additional products. The one or more product attributes for each of the additional products may be compared with the one or more catalog attributes utilized within the master catalog to map at least one of the one or more product attributes for the additional products onto at least one of the one or more catalog attributes utilized within the master catalog. The electronic distributor catalog may be provided in a format chosen from the group consisting of: a spreadsheet format and XML format. The master catalog may be an online catalog.

In another implementation, a computing system includes at least one processor and at least one memory architecture coupled with the at least one processor, wherein the computing system is configured to perform operations including identifying a first product offered by a product distributor within an electronic distributor catalog for inclusion within a master catalog. The first product is processed to extract one or more product attributes for the first product. The one or more product attributes for the first product are compared with one or more catalog attributes utilized within the master catalog to map at least one of the one or more product attributes for the first product onto at least one of the one or more catalog attributes utilized within the master catalog.

One or more of the following features may be included. Comparing the one or more product attributes for the first product with one or more catalog attributes utilized within the master catalog may include reviewing historical/current product attribute mappings within the master catalog to map at least one of the one or more product attributes for the first product onto at least one of the one or more catalog attributes utilized within the master catalog. Comparing the one or more product attributes for the first product with one or more catalog attributes utilized within the master catalog nay include reviewing attributes names included within the one or more product attributes for the first product with attribute names included within the one or more catalog attributes utilized within the master catalog to map at least one of the one or more product attributes for the first product onto at least one of the one or more catalog attributes utilized within the master catalog. Comparing the one or more product attributes for the first product with one or more catalog attributes utilized within the master catalog may include reviewing attributes values included within the one or more product attributes for the first product with attribute values included within the one or more catalog attributes utilized within the master catalog to map at least one of the one or more product attributes for the first product onto at least one of the one or more catalog attributes utilized within the master catalog.

Additional products offered by the product distributor within the electronic distributor catalog may be identified for inclusion within the master catalog. The additional products may be processed to extract one or more product attributes for each of the additional products. The one or more product attributes for each of the additional products may be compared with the one or more catalog attributes utilized within the master catalog to map at least one of the one or more product attributes for the additional products onto at least one of the one or more catalog attributes utilized within the master catalog. The electronic distributor catalog may be provided in a format chosen from the group consisting of: a spreadsheet format and XML format. The master catalog may be an online catalog.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a product importation process coupled to a distributed computing network;

FIG. 2 is a flow chart of one implementation of the product importation process of FIG. 1;

FIG. 3 is a diagrammatic view of the mapping of product attributes onto catalog attributes as performed by the product importation process of FIG. 1;

FIG. 4 is a flow chart of another implementation of the product importation process of FIG. 1; and

FIG. 5 is a flow chart of another implementation of the product importation process of FIG. 1.

Like reference symbols in the various drawings indicate like elements.

### DETAILED DESCRIPTION OF THE PREFERRED EMBODIMENTS

### System Overview:

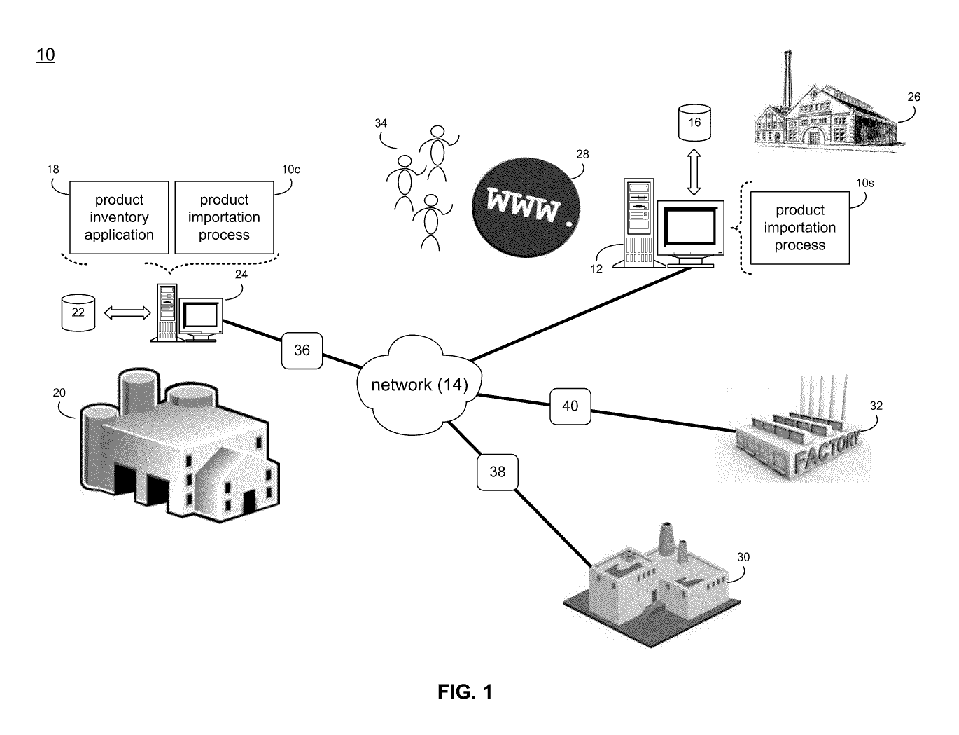

Referring to FIG. 1, there is shown product importation process 10. As will be discussed below in greater detail, product importation process 10 may be configured to assist in the importation and inclusion of products (e.g., offered for sale by third party producers/distributors) into a catalog of a product reseller.

Product importation process 10 may be implemented on one or more computing systems. For example, product importation process 10 may be implemented as a purely server-side process via server-side product importation process 10s. Alternatively, product importation process 10 may be implemented as a purely client-side process via client-side product importation process 10c. Alternatively still, product importation process 10 may be implemented as a hybrid server-side/client-side process via server-side product importation process 10s in combination with client-side product importation process 10c. Accordingly, product importation process 10 as used in this disclosure may include any combination of server-side product importation process 10s and client-side product importation process 10c.

For example, client-side product importation process 10c may be an application/process that is executed by one of the above-mentioned third-party producers/distributors. Server-side product importation process 10s may be an application/process that is executed by the above-mentioned product reseller. Alternatively, product importation process 10 may be a data importation service offered by a third party service provider, which processes the data provided by the above-mentioned third-party producer/distributor and provides data to the above-mentioned product reseller.

Server-side product importation process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of server-side product importation process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices. Any data generated, in whole or in part, by server-side product importation process 10s may be stored on storage device 16 coupled to computing device 12.

Client-side product importation process 10c may be a stand-alone application or may be a portion of/a subroutine within/an applet within a product inventory application 18 utilized by third-party producer/distributor 20. The instruction sets and subroutines of client-side product importation process 10c, which may be stored on storage device 22 coupled to computing device 24, may be executed by one or more processors (not shown) and one or more memory architectures (not shown) incorporated into computing device 24. Examples of storage device 22 may include but are not limited to: a hard disk drive; a tape drive; an optical drive; a RAID device; a random access memory (RAM); a read-only memory (ROM); and all forms of flash memory storage devices. Any data generated, in whole or in part, by client-side product importation process 10c may be stored on storage device 22 coupled to computing device 24.

Examples of computing device 24 may include, but are not limited to a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

Computing device 12 (and server-side product importation process 10s) may communicate with computing device 24 (and client-side product importation process 10c) via network 14.

### Product Importation Process:

For the following example, assume that reseller business 26 is an internet-based retailer (such as an Amazon.com™) that sells, via a master catalog 28 (e.g., a retail website) products that are produced/distributed by third-party producers/distributors (e.g., third-party producer/distributor 20, third-party producer/distributor 30, third-party producer/distributor 32). The products may then be purchased by various consumers (e.g., consumers 34) via master catalog 28. Accordingly and for this example, various products are produced/distributed by third-party producer/distributor 20, third-party producer/distributor 30, and third-party producer/distributor 32; and are offered for sale by reseller business 26 via master catalog 28.

Accordingly and to offer for sale such products produced/distributed by third-party producer/distributor 20, third-party producer/distributor 30, and third-party producer/distributor 32 on master catalog 28, reseller business 26 maintains master catalog 28 so that master catalog 28 identifies/includes all of the products produced/distributed by third-party producer/distributor 20, third-party producer/distributor 30, and third-party producer/distributor 32 that reseller business 26 intends to offer for sale. Therefore, the third party producers/distributers (e.g., third-party producer/distributor 20, third-party producer/distributor 30, third-party producer/distributor 32) may each provide to reseller business 26 an electronic distributor catalog (e.g., distributor catalog 36, 38, 40) in a format that may be processed by product importation process 10. Example of such a format may include but are not limited to a spreadsheet format and an XML format. Distributor catalogs 36, 38, 40 may identify to reseller business 26 the products produced/distributed by third-party producer/distributor 20, third-party producer/distributor 30, and third-party producer/distributor 32 (respectively) so that reseller business 26 may update master catalog 28 to include such products.

While the following example concerns reseller business 26 being an e-tailer (i.e., an electronic retailer) in which master catalog 28 (in this example) is a retail website, this is for illustrative purposes only and is not intended to be a limitation of this disclosure, as other configurations are possible and are considered to be within the scope of this disclosure. For example, reseller business 26 may be a traditional bricks-n-mortar retail business and master catalog 28 may be a traditional printed catalog that identifies the products that are produced/distributed by third-party producer/distributor 20, third-party producer/distributor 30, and third-party producer/distributor 32 and offered for sale by reseller business 26.

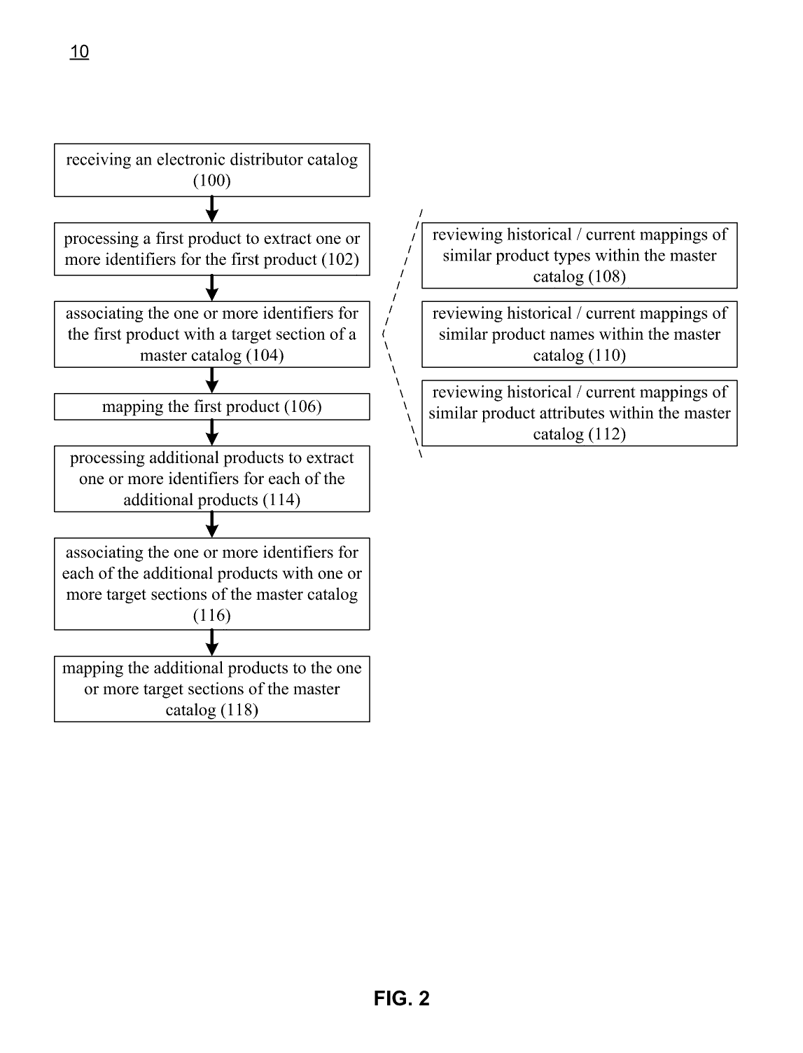

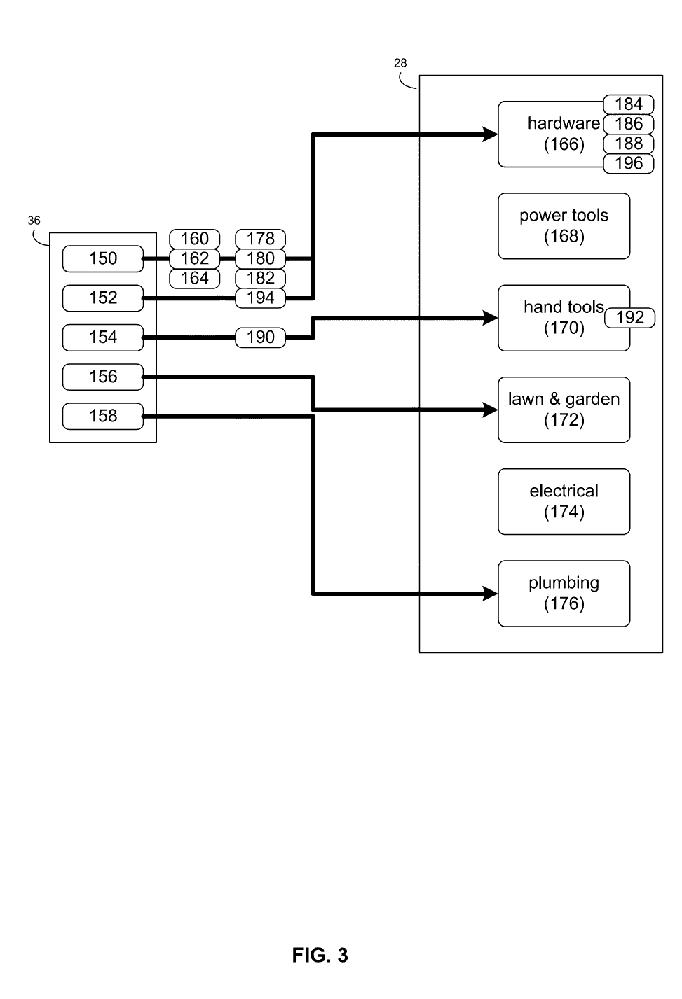

Referring also to FIGS. 2-3, product importation process 10 may receive 100 an electronic distributor catalog (e.g., distributor catalog 36) that defines a plurality of products offered by a product distributor (e.g., third-party producer/distributor 20). As discussed above, the third party producers/distributers (e.g., third-party producer/distributor 20) may provide to reseller business 26 an electronic distributor catalog (e.g., distributor catalog 36) in a format that may be processed by product importation process 10, wherein distributor catalog 36 identifies to reseller business 26 the products (e.g., products 150, 152, 154, 156, 158) produced/distributed by third-party producer/distributor 20 so that reseller business 26 may update master catalog 28 (e.g., a retail website) to include such products.

Product importation process 10 may process 102 a first product (e.g., product 150), chosen from the plurality of products (e.g., products 150, 152, 154, 156, 158) defined within electronic distributor catalog (e.g., distributor catalog 36), to extract one or more identifiers (e.g., identifiers 160, 162, 164) for the first product (e.g., product 150).

As will be discussed below in greater detail, product importation process 10 may associate 104 the one or more identifiers (e.g., identifiers 160, 162, 164) for the first product (e.g., product 150) with a target section (e.g., target section 166) of master catalog 28 (e.g., a retail website). Master catalog 28 may be divided into a plurality of predefined sections (e.g., sections 166, 168, 170, 172, 174, 176) from which target section 166 may be chosen. As discussed above, an example of master catalog 28 is a retail website, wherein this retail website may be divided into various sections, such as “hardware” section 166, “power tools” section 168, “hand tools” section 170, “lawn & garden” section 172, “electrical” section 174 and “plumbing” section 176.

Once a first product (e.g., product 150) is associated 104 with a target section (e.g., target section 166), product importation process 10 may map 106 this first product (e.g., product 150), chosen from the plurality of products (e.g., products 150, 152, 154, 156, 158) defined within the electronic distributor catalog (e.g., distributor catalog 36), to the target section (e.g., “hardware” section 166) of master catalog 28.

Since master catalog 28 may be divided into a plurality of predefined sections (e.g., sections 166, 168, 170, 172, 174, 176), product importation process 10 may first need to identify the target section into which the product being processed should be placed. As discussed above, in order to identify this target section, product importation process 10 may process the identifiers (e.g., identifiers 160, 162, 164) extracted for the first product (e.g., product 150) to associate 104 them with a target section of master catalog 28 (e.g., a retail website).

For example, these identifiers (e.g., identifiers 160, 162, 164) for product 150 may include a product type (e.g., “fastener”) and associating 104 the identifiers (e.g., identifiers 160, 162, 164) for product 150 with a target section of master catalog 28 may include reviewing 108 historical/current mappings of similar product types within master catalog 28 to associate the identifier (e.g., “fastener”) for product 150 with the target section. Accordingly, assume that reviewing 108 historical mappings for products including the identifier “fastener” (and words similar thereto) indicate that these “fastener” type products are typically included within “hardware” section 166 of master catalog 28. Accordingly, product importation process 10 may map 106 product 150 to “hardware” section 166 of master catalog 28.

Additionally/alternatively, these identifiers (e.g., identifiers 160, 162, 164) for product 150 may include a product name (e.g., “screw”) and associating 104 the identifiers (e.g., identifiers 160, 162, 164) for product 150 with a target section of master catalog 28 may include reviewing 110 historical/current mappings of similar product names within master catalog 28 to associate the identifier (e.g., “screw”) for product 150 with the target section. Accordingly, assume that reviewing 110 historical mappings for products including the identifier “screw” (and words similar thereto) indicate that these “screw” name products are typically included within “hardware” section 166 of master catalog 28. Accordingly, product importation process 10 may map 106 product 150 to “hardware” section 166 of master catalog 28.

Additionally/alternatively, these identifiers (e.g., identifiers 160, 162, 164) for product 150 may include a product attribute (e.g., “coarse thread”) and associating 104 the identifiers (e.g., identifiers 160, 162, 164) for product 150 with a target section of master catalog 28 may include reviewing 112 historical/current mappings of similar product attributes within master catalog 28 to associate the identifier (e.g., “coarse thread”) for product 150 with the target section. Accordingly, assume that reviewing 112 historical mappings for products including the identifier “coarse thread” (and words similar thereto) indicate that these “coarse thread” attribute products are typically included within “hardware” section 166 of master catalog 28. Accordingly, product importation process 10 may map 106 product 150 to “hardware” section 166 of master catalog 28.

While the above discussion concerns product importation process 10 processing a single product (e.g., product 150) defined within an electronic distributor catalog (e.g., distributor catalog 36), product importation process 10 may continue to process (in this example) distributer catalog 36 until completely processed. Accordingly, product importation process 10 may: process 114 additional products (e.g., products 152, 154, 156, 158), chosen from the plurality of products (e.g., products 150, 152, 154, 156, 158) defined within electronic distributor catalog (e.g., distributor catalog 36), to extract one or more identifiers (not shown) for each of the additional products (e.g., products 152, 154, 156, 158); associate 116 these extracted identifiers (not shown) for each of the additional products (e.g., products 152, 154, 156, 158) with one or more target sections (e.g., sections 166, 168, 170, 172, 174, 176) of master catalog 28; and map 118 these additional products (e.g., products 152, 154, 156, 158) to the one or more target sections (e.g., sections 166, 168, 170, 172, 174, 176) of master catalog 28.

Once the products (e.g., products 150, 152, 154, 156, 158) defined within electronic distributor catalog (e.g., distributor catalog 36) are each mapped to (i.e., associated with) a target section (e.g., sections 166, 168, 170, 172, 174, 176) of master catalog 28, product importation process 10 may further analyze and process these products so that they may be included within/added to the identified sections (e.g., sections 166, 168, 170, 172, 174, 176) of master catalog 28. For example and in the situation where master catalog 28 is a retail website, product importation process 10 may analyze and process these products so that they may be included within/added to the identified sections (e.g., sections 166, 168, 170, 172, 174, 176) of the retail website, thus allowing consumers (e.g., consumers 34) to purchase (e.g., products 150, 152, 154, 156, 158).

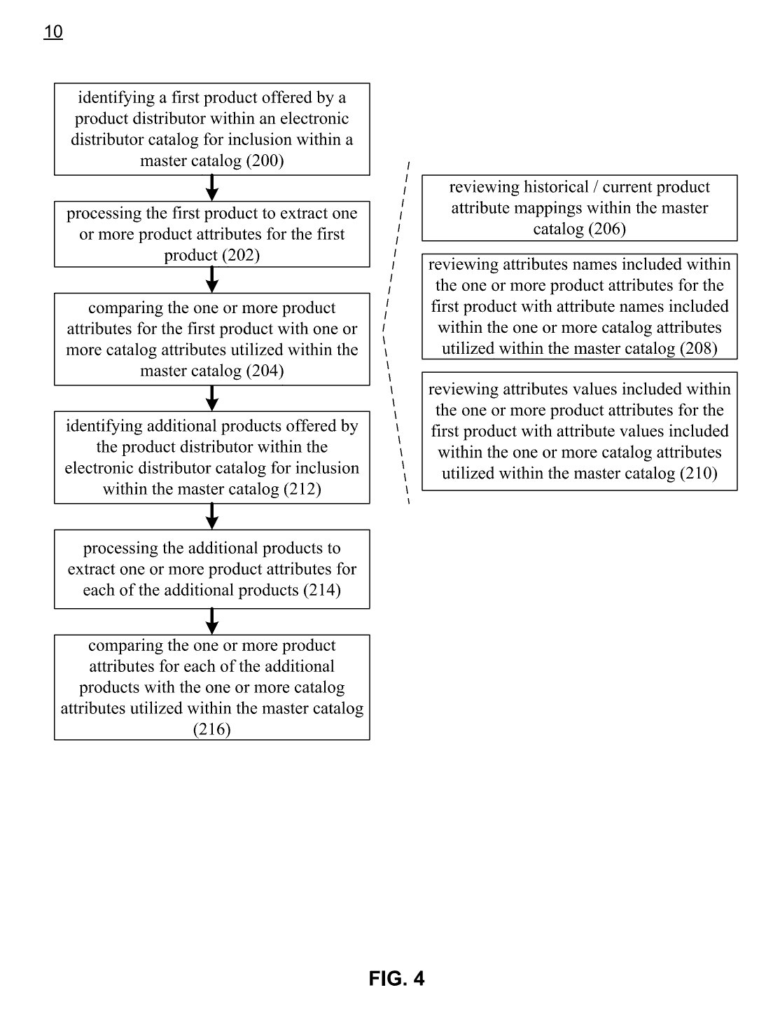

Referring also to FIG. 4 and continuing with the above-stated example in which product 150 was mapped 106 to target section 166 (i.e., the “hardware” section) of master catalog 28, product importation process 10 may identify 200 a first product (e.g., product 150) offered by a product distributor (e.g., third-party producer/distributor 20) within an electronic distributor catalog (e.g., distributor catalog 36) for inclusion within master catalog 28 (in this particular example, “hardware” section 166 or master catalog 28).

Product importation process 10 may process 202 the first product (e.g., product 150) to extract one or more product attributes (e.g., attributes 178, 180, 182) for the first product (e.g., product 150). As will be discussed below in greater detail, product importation process 10 may compare 204 the one or more product attributes (e.g., attributes 178, 180, 182) for the first product (e.g., product 150) with one or more catalog attributes (e.g., attributes 184, 186, 188) utilized within master catalog 28 to map at least one of the one or more product attributes (e.g., attributes 178, 180, 182) for the first product (e.g., product 150) onto at least one of the one or more catalog attributes (e.g., attributes 184, 186, 188) utilized within master catalog 28. Specifically, the product attributes (e.g., attributes 178, 180, 182) utilized to define the first product (e.g., product 150) may be different than the catalog attributes (e.g., attributes 184, 186, 188) utilized within master catalog 28. Accordingly, product importation process 10 may be configured to alleviate such ambiguities between attributes.

Examples of such product attributes (e.g., attributes 178, 180, 182) and catalog attributes (e.g., attributes 184, 186, 188) may include attributes that define the specific product (e.g., “fastener type”, “material”, “length”, head type”, “thread type”).

Continuing with the above-stated example, assume that product attribute 178 is “material” and catalog attribute 184 is “finish”. When comparing 204 the product attributes (e.g., attributes 178, 180, 182) for product 150 with the catalog attributes (e.g., attributes 184, 186, 188) utilized within master catalog 28, product importation process 10 may review 206 historical/current product attribute mappings within master catalog 28 to map at least one of the one or more product attributes (e.g., attributes 178, 180, 182) for product 150 onto at least one of the one or more catalog attributes (e.g., attributes 184, 186, 188) utilized within master catalog 28. Accordingly, assume that reviewing 206 historical/current product attribute mappings indicate that the product attribute “material” (e.g., product attribute 178) is typically mapped to the catalog attribute “finish” (e.g., catalog attribute 184). Accordingly, product importation process 10 may map the product attribute “material” (e.g., product attribute 178) to the catalog attribute “finish” (e.g., catalog attribute 184).

Additionally/alternatively, when comparing 204 the product attributes (e.g., attributes 178, 180, 182) for product 150 with the catalog attributes (e.g., attributes 184, 186, 188) utilized within master catalog 28, product importation process 10 may review 208 attributes names included within the one or more product attributes (e.g., attributes 178, 180, 182) for product 150 with attribute names included within the one or more catalog attributes (e.g., attributes 184, 186, 188) utilized within master catalog 28 to map at least one of the one or more product attributes (e.g., attributes 178, 180, 182) for product 150 onto at least one of the one or more catalog attributes (e.g., attributes 184, 186, 188) utilized within master catalog 28. For example, assume that product attribute 180 is “fastener type” and catalog attribute 186 is “fastener style”. Accordingly, as these attributes are quite similar, product importation process 10 may map product attribute 180 for product 150 onto catalog attribute 186 utilized within master catalog 28.

Additionally/alternatively, when comparing 204 the product attributes (e.g., attributes 178, 180, 182) for product 150 with the catalog attributes (e.g., attributes 184, 186, 188) utilized within master catalog 28, product importation process 10 may review 210 attributes values included within the one or more product attributes (e.g., attributes 178, 180, 182) for product 150 with attribute values included within the one or more catalog attributes (e.g., attributes 184, 186, 188) utilized within master catalog 28 to map at least one of the one or more product attributes (e.g., attributes 178, 180, 182) for product 150 onto at least one of the one or more catalog attributes (e.g., attributes 184, 186, 188) utilized within master catalog 28. For example, assume that product attribute 182 defines a length in inches and catalog attribute 188 also defines a length in inches. Accordingly, as both of these attributes define a length in inches, product importation process 10 may map product attribute 182 for product 150 onto catalog attribute 188 utilized within master catalog 28

While the above discussion concerns product importation process 10 processing a single product (e.g., product 150) defined within an electronic distributor catalog (e.g., distributor catalog 36), product importation process 10 may continue to process (in this example) distributer catalog 36 until completely processed. Accordingly, product importation process 10 may: identify 212 additional products (e.g., products 152, 154, 156, 158) offered by the product distributor (e.g., third-party producer/distributor 20) within the electronic distributor catalog (e.g., distributor catalog 36) for inclusion within master catalog 28; process 214 the additional products (e.g., products 152, 154, 156, 158) to extract one or more product attributes (not shown) for each of the additional products (e.g., products 152, 154, 156, 158); and compare 216 the one or more product attributes (not shown) for each of the additional products (e.g., products 152, 154, 156, 158) with the one or more catalog attributes (e.g., attributes 184, 186, 188) utilized within master catalog 28 to map at least one of the product attributes for the additional products (e.g., products 152, 154, 156, 158) onto at least one of the catalog attributes utilized within master catalog 28.

Unfortunately, sometimes the format of the attributes that are provided by the product distributor (e.g., third-party producer/distributor 20) are quite different than the format that reseller business 26 wishes to use in master catalog 28. For example, third-party producer/distributor 20 may be a Canadian company and may define their products using the metric system and reseller business 26 may be a US company and may want to define the products that they are selling using imperial units. Accordingly, product importation process 10 may be configured to effectuate such transformations.

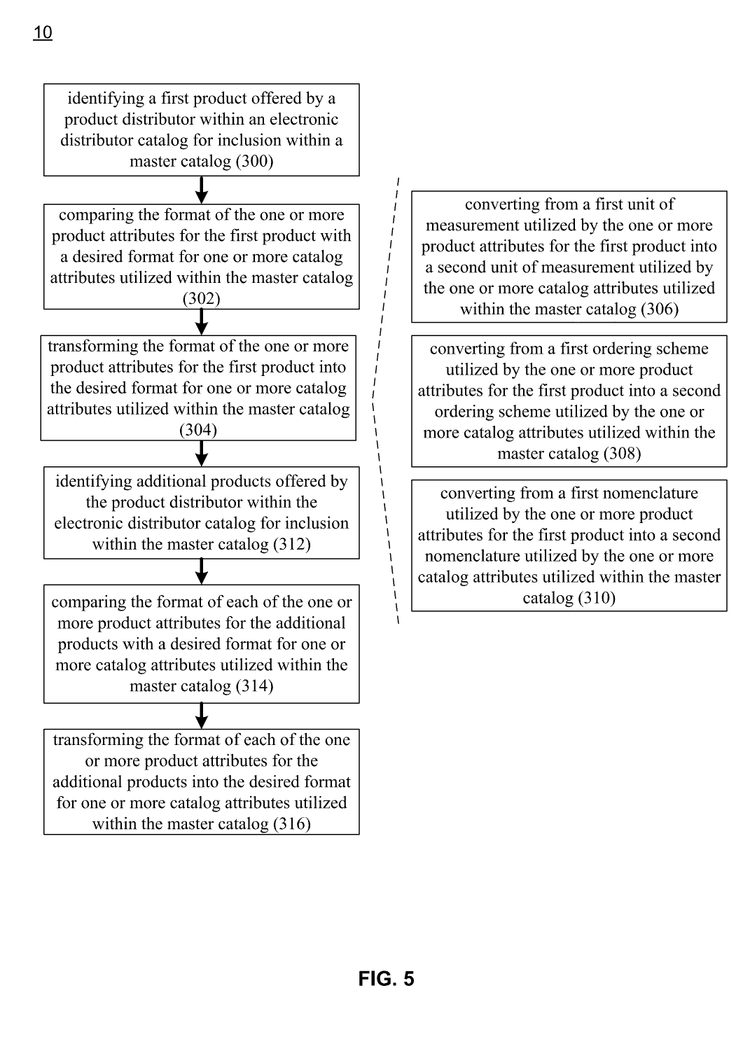

Referring also to FIG. 5 and continuing with the above-stated example in which product 150 was mapped 106 to target section 166 (i.e., the “hardware” section), product importation process 10 may identify 300 a first product (e.g., product 150) offered by a product distributor (e.g., third-party producer/distributor 20) within an electronic distributor catalog (e.g., distributor catalog 36) for inclusion within master catalog 28. As discussed above, product 150 may be identified using one or more product attributes (e.g., attributes 178, 180, 182).

As will be discussed below in greater detail, product importation process 10 may compare 302 the format of the one or more product attributes (e.g., attributes 178, 180, 182) for product 150 with a desired format for one or more catalog attributes (e.g., attributes 184, 186, 188) utilized within master catalog 28 and may transform 304 the format of the one or more product attributes (e.g., attributes 178, 180, 182) for product 150 into the desired format for one or more catalog attributes (e.g., attributes 184, 186, 188) utilized within master catalog 28.

For example, when transforming 304 the format of the one or more product attributes (e.g., attributes 178, 180, 182) for product 150 into the desired format for one or more catalog attributes (e.g., attributes 184, 186, 188) utilized within master catalog 28, product importation process 10 may convert 306 from a first unit of measurement utilized by the one or more product attributes (e.g., attributes 178, 180, 182) for product 150 into a second unit of measurement utilized by the one or more catalog attributes (e.g., attributes 184, 186, 188) utilized within master catalog 28. For example and as discussed above, assume that third-party producer/distributor 20 is a Canadian company that defines product 150 (e.g., a screw) using a metric product attribute (e.g., the screw has a length of 25 millimeters) and reseller business 26 is a US company that wants to define the products that they are selling (including product 150) using an imperial catalog attribute. Accordingly, product importation process 10 may convert 306 metric product attribute 182 (e.g., from a first unit of measurement, namely metric) into a second unit of measurement (namely imperial) so that it may properly map to catalog attribute 188 (which is imperial), as utilized within master catalog 28

Additionally/alternatively, when transforming 304 the format of the one or more product attributes (e.g., attributes 178, 180, 182) for product 150 into the desired format for one or more catalog attributes (e.g., attributes 184, 186, 188) utilized within master catalog 28, product importation process 10 may convert 308 from a first ordering scheme utilized by the one or more product attributes (e.g., attributes 178, 180, 182) for product 150 into a second ordering scheme utilized by the one or more catalog attributes (e.g., attributes 184, 186, 188) utilized within master catalog 28. For example, assume that product attribute 190 for product 154 offered by third-party producer/distributor 20 includes a plurality of values (e.g., the various socket sizes included within a ½″ drive socket set), wherein product attribute 190 orders these various sizes from smallest to largest. However, catalog attribute 192 to which product attribute 190 is mapped orders these various sizes from largest to smallest. Accordingly, product importation process 10 may convert 308 product attribute 190 for product 154 from a first ordering scheme (e.g., smallest to largest) into a second ordering scheme (e.g., largest to smallest) so that it may properly map to catalog attribute 192, as utilized within master catalog 28.

Additionally/alternatively, when transforming 304 the format of the one or more product attributes (e.g., attributes 178, 180, 182) for product 150 into the desired format for one or more catalog attributes (e.g., attributes 184, 186, 188) utilized within master catalog 28, product importation process 10 may convert 310 from a first nomenclature utilized by the one or more product attributes (e.g., attributes 178, 180, 182) for product 150 into a second nomenclature utilized by the one or more catalog attributes (e.g., attributes 184, 186, 188) utilized within master catalog 28. For example, assume that product attribute 194 for product 152 offered by third-party producer/distributor 20 includes the acronym “SS” for stainless steel, the material from which product 152 (e.g., a nail) is constructed, wherein catalog attribute 196 (the catalog attribute to which product attribute 194 is mapped) does not use acronyms and only uses full names (e.g., stainless steel). Accordingly, product importation process 10 may convert 310 product attribute 194 for product 152 from its acronym format (“SS”) into a full word format (e.g., “stainless steel”) so that it may properly map to catalog attribute 196, as utilized within master catalog 28. Product importation process 10 may also be utilized to convert 310 a product attribute from a first language into a second language.

While the previous discussion concerned product importation process 10 processing single products (e.g., products 150, 152, 154) defined within an electronic distributor catalog (e.g., distributor catalog 36), product importation process 10 may continue to process (in this example) distributer catalog 36 until completely processed. Accordingly, product importation process 10 may: identify 312 additional products (e.g., products 156, 158) offered by the product distributor (e.g., third-party producer/distributor 20) within the electronic distributor catalog (e.g., distributor catalog 36) for inclusion within master catalog 28, wherein the additional products (e.g., products 156, 158) are each identified using one or more product attributes (not shown); compare 314 the format of each of the one or more product attributes (not shown) for the additional products (e.g., products 156, 158) with a desired format for one or more catalog attributes (e.g., attributes 184, 186, 188, 192, 196) utilized within master catalog 28; and transform 316 the format of each of the one or more product attributes (not shown) for the additional products (e.g., products 156, 158) into the desired format for one or more catalog attributes (e.g., attributes 184, 186, 188, 192, 196) utilized within master catalog 28.

While the above discussions concerned the processing of distributor catalog 36, product importation process 10 may accomplish the processing of distributor catalogs 38, 40 in a similar fashion.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
identifying a first product offered by a product distributor within an electronic distributor catalog for inclusion within a master catalog;
processing the first product to extract one or more product attributes for the first product; and
comparing the one or more product attributes for the first product with one or more catalog attributes utilized within the master catalog to map at least one of the one or more product attributes for the first product onto at least one of the one or more catalog attributes utilized within the master catalog.

2. The computer-implemented method of claim 1 wherein comparing the one or more product attributes for the first product with one or more catalog attributes utilized within the master catalog includes:
reviewing historical/current product attribute mappings within the master catalog to map at least one of the one or more product attributes for the first product onto at least one of the one or more catalog attributes utilized within the master catalog.

3. The computer-implemented method of claim 1 wherein comparing the one or more product attributes for the first product with one or more catalog attributes utilized within the master catalog includes:
reviewing attributes names included within the one or more product attributes for the first product with attribute names included within the one or more catalog attributes utilized within the master catalog to map at least one of the one or more product attributes for the first product onto at least one of the one or more catalog attributes utilized within the master catalog.

4. The computer-implemented method of claim 1 wherein comparing the one or more product attributes for the first product with one or more catalog attributes utilized within the master catalog includes:
reviewing attributes values included within the one or more product attributes for the first product with attribute values included within the one or more catalog attributes utilized within the master catalog to map at least one of the one or more product attributes for the first product onto at least one of the one or more catalog attributes utilized within the master catalog.

5. The computer-implemented method of claim 1 further comprising:
identifying additional products offered by the product distributor within the electronic distributor catalog for inclusion within the master catalog;
processing the additional products to extract one or more product attributes for each of the additional products; and
comparing the one or more product attributes for each of the additional products with the one or more catalog attributes utilized within the master catalog to map at least one of the one or more product attributes for the additional products onto at least one of the one or more catalog attributes utilized within the master catalog.

6. The computer-implemented method of claim 1 wherein the electronic distributor catalog is provided in a format chosen from the group consisting of: a spreadsheet format and XML format.

7. The computer-implemented method of claim 1 wherein the master catalog is an online catalog.

8. A computer program product residing on a computer readable medium having a plurality of instructions stored thereon which, when executed by a processor, cause the processor to perform operations comprising:
identifying a first product offered by a product distributor within an electronic distributor catalog for inclusion within a master catalog;
processing the first product to extract one or more product attributes for the first product; and
comparing the one or more product attributes for the first product with one or more catalog attributes utilized within the master catalog to map at least one of the one or more product attributes for the first product onto at least one of the one or more catalog attributes utilized within the master catalog.

9. The computer program product of claim 8 wherein the instructions for comparing the one or more product attributes for the first product with one or more catalog attributes utilized within the master catalog include instructions for:
reviewing historical/current product attribute mappings within the master catalog to map at least one of the one or more product attributes for the first product onto at least one of the one or more catalog attributes utilized within the master catalog.

10. The computer program product of claim 8 wherein the instructions for comparing the one or more product attributes for the first product with one or more catalog attributes utilized within the master catalog include instructions for:
reviewing attributes names included within the one or more product attributes for the first product with attribute names included within the one or more catalog attributes utilized within the master catalog to map at least one of the one or more product attributes for the first product onto at least one of the one or more catalog attributes utilized within the master catalog.

11. The computer program product of claim 8 wherein the instructions for comparing the one or more product attributes for the first product with one or more catalog attributes utilized within the master catalog include instructions for:
reviewing attributes values included within the one or more product attributes for the first product with attribute values included within the one or more catalog attributes utilized within the master catalog to map at least one of the one or more product attributes for the first product onto at least one of the one or more catalog attributes utilized within the master catalog.

12. The computer program product of claim 8 further comprising instructions for:
identifying additional products offered by the product distributor within the electronic distributor catalog for inclusion within the master catalog;
processing the additional products to extract one or more product attributes for each of the additional products; and
comparing the one or more product attributes for each of the additional products with the one or more catalog attributes utilized within the master catalog to map at least one of the one or more product attributes for the additional products onto at least one of the one or more catalog attributes utilized within the master catalog.

13. The computer program product of claim 8 wherein the electronic distributor catalog is provided in a format chosen from the group consisting of: a spreadsheet format and XML format.

14. The computer program product of claim 8 wherein the master catalog is an online catalog.

15. A computing system including a processor and memory configured to perform operations comprising:
identifying a first product offered by a product distributor within an electronic distributor catalog for inclusion within a master catalog;
processing the first product to extract one or more product attributes for the first product; and
comparing the one or more product attributes for the first product with one or more catalog attributes utilized within the master catalog to map at least one of the one or more product attributes for the first product onto at least one of the one or more catalog attributes utilized within the master catalog.

16. The computing system of claim 15 wherein comparing the one or more product attributes for the first product with one or more catalog attributes utilized within the master catalog includes:
reviewing historical/current product attribute mappings within the master catalog to map at least one of the one or more product attributes for the first product onto at least one of the one or more catalog attributes utilized within the master catalog.

17. The computing system of claim 15 wherein comparing the one or more product attributes for the first product with one or more catalog attributes utilized within the master catalog includes:
reviewing attributes names included within the one or more product attributes for the first product with attribute names included within the one or more catalog attributes utilized within the master catalog to map at least one of the one or more product attributes for the first product onto at least one of the one or more catalog attributes utilized within the master catalog.

18. The computing system of claim 15 wherein comparing the one or more product attributes for the first product with one or more catalog attributes utilized within the master catalog includes:
reviewing attributes values included within the one or more product attributes for the first product with attribute values included within the one or more catalog attributes utilized within the master catalog to map at least one of the one or more product attributes for the first product onto at least one of the one or more catalog attributes utilized within the master catalog.

19. The computing system of claim 15 further configured to perform operations comprising:
identifying additional products offered by the product distributor within the electronic distributor catalog for inclusion within the master catalog;
processing the additional products to extract one or more product attributes for each of the additional products; and
comparing the one or more product attributes for each of the additional products with the one or more catalog attributes utilized within the master catalog to map at least one of the one or more product attributes for the additional products onto at least one of the one or more catalog attributes utilized within the master catalog.

20. The computing system of claim 15 wherein the electronic distributor catalog is provided in a format chosen from the group consisting of: a spreadsheet format and XML format.

21. The computing system of claim 15 wherein the master catalog is an online catalog.
